(19) United States
(12) Patent Application Publication
(10) Pub. No.: US 2020/0017013 A1
(43) Pub. Date: Jan. 16, 2020

(54) SYSTEMS, APPARATUS, AND METHODS FOR AN IMPROVED BOAT TRAILER LAUNCH AND LOADING SYSTEM

(71) Applicants: Harold A. Records, North Kingston, RI (US); Paul B. Records, South Kingston, RI (US)

(72) Inventors: Harold A. Records, North Kingston, RI (US); Paul B. Records, South Kingston, RI (US)

(21) Appl. No.: 16/513,052

(22) Filed: Jul. 16, 2019

Related U.S. Application Data
(60) Provisional application No. 62/698,926, filed on Jul. 16, 2018.

(51) Int. Cl. B60P 3/10

(52) U.S. Cl. CPC B60P 3/1066

(57) ABSTRACT

Improved boat trailering systems, methods, and apparatus are provided that include a boat trailer and a pivot arm assembly coupled to the boat trailer and adapted to hold a winch hook in reach of a bow of a boat to be loaded onto or launched from the boat trailer. The pivot arm assembly is operative to pivot horizontal under the boat when the boat is loaded on the boat trailer and biased to pivot up into a vertical position when the boat is launched from the boat trailer. Numerous additional aspects are disclosed.

### FIELD

The present invention relates to boat trailering, and more specifically to systems, apparatus, and methods for an improved boat trailer launch and loading system.

### BACKGROUND

Powerboats that can be easily towed behind a pickup truck or sport utility vehicle represent a significant portion of all registered powerboats in the United States. Mobility, variety of destination (e.g., ocean, bay, lake, pond, rivers, etc.) and multiple uses (e.g., fishing, cruising, wakeboarding, water skiing, sightseeing, picnicking, etc.) all add to the appeal and growth of trailer boating. However, all trailer boaters are faced with two unavoidable events, launching and loading, that can be challenging, time consuming, stressful and dangerous. Injuries from slips and falls are not uncommon. Boat ramps can be steep, wet and slippery with marine growth, uneven surfaces, rocks, shells, shifting sand or other hazards underfoot. Water quality varies widely. Frequently it is cold and opaque. Sprains, strains, and broken bones can occur when cranking/releasing manual winches or climbing in and out of a boat on a trailer without using a purpose designed boarding attachment. Various innovative efforts in designing boat launch and haul systems for trailers have yielded structures, which have attempted to address several of the problems inherent in retrieving, loading, transporting and launching marine-type vehicles.

Conventional boat trailers typically use a manual winch system to load a boat from the water onto a trailer. Once a boat trailer is backed partially into the water via a slipway or boat ramp, a hook on the end of a rope or strap of the winch is attached to a “bow eye” (i.e., a loop mounted to the front of the boat) and by turning the winch, the boat is pulled out of the water and up onto the trailer, which is then pulled out of the water by the tow vehicle. Unfortunately, attaching the hook to the bow eye usually requires the user to wade into the water to extend the hook to reach the bow eye. Getting wet just to make this connection is inconvenient at the least and can be both unpleasant and dangerous in icy conditions. Thus, what is needed are systems, apparatus, and methods for an improved boat trailer launch and loading system.

### SUMMARY

In some embodiments, the present invention provides an improved system for loading and launching a boat from a trailer into water. The system can include a pivot arm assembly that can be mounted on a trailer crossbeam. The pivot arm assembly is adapted to hold the winch hook in easy reach of a user when loading and launching a boat which facilitates single handed operation. The pivot arm assembly conveniently and automatically swings out of the way for storage under the boat as the boat is loaded on to the trailer and swings upward into easy reach as the boat is launched.

Still other features, aspects, and advantages of the present invention will become more fully apparent from the following detailed description, the appended claim, and the accompanying drawings by illustrating a number of exemplary embodiments and implementations for carrying out the present invention. Embodiments of the present invention may also be capable of other and different applications, and its several details may be modified in various respects, all without departing from the spirit and scope of the present invention. Accordingly, the drawings and descriptions are to be regarded as illustrative in nature, and not as restrictive. The drawings are not necessarily drawn to scale. The description is intended to cover all modifications, equivalents, and alternatives falling within the spirit and scope of the claims.

### BRIEF DESCRIPTION OF THE DRAWINGS

FIG. 1 is a front perspective view diagram depicting an example of a boat trailer system according to embodiments of the present invention.

FIG. 2 is a side view diagram depicting an example of a boat trailer system according to embodiments of the present invention.

FIG. 3 is an end view diagram depicting an example of a boat trailer system according to embodiments of the present invention.

FIG. 4 is a top view diagram depicting an example of a boat trailer system according to embodiments of the present invention.

FIG. 5 is a side view diagram depicting an example of a boat trailer system ready for use to load a boat according to embodiments of the present invention.

FIG. 6 is a side view diagram depicting an example of a boat trailer system in use according to embodiments of the present invention.

FIG. 7 is a side view diagram depicting an example of a boat trailer system with a boat loaded according to embodiments of the present invention.

FIG. 8 is a magnified view of an example of a pivot arm assembly of a boat trailer system according to embodiments of the present invention.

FIG. 9 is a magnified view of a first portion of an example of a pivot arm assembly of a boat trailer system according to embodiments of the present invention.

FIG. 10 is a magnified view of a second portion of an example of a pivot arm assembly of a boat trailer system according to embodiments of the present invention.

FIG. 11 is a further magnified view of a mounting portion of an example of a pivot arm assembly of a boat trailer system according to embodiments of the present invention.

FIG. 12 is a further magnified view of a roller portion of an example of a pivot arm assembly of a boat trailer system according to embodiments of the present invention.

FIG. 13 is a rear perspective view diagram depicting an example of a boat trailer system according to embodiments of the present invention.

### DESCRIPTION

Embodiments of the present invention provide systems, apparatus, and methods for an improved boat trailer system that facilitates single user launching and loading without requiring the user to enter the water. The boat trailer system includes a pivot arm assembly that pivots easily from a horizontal to a vertical position while mounted on a trailer cross beam typically located forward of the trailer's axel. In some embodiments, the pivot arm assembly can be provided independently of the trailer as a kit for later attachment to the trailer by a user. The pivot arm of the pivot arm assembly can be manufactured from aluminum or any suitable (e.g., light weight, salt-waterproof, etc.) material. Embodiments of the present invention can also include an electric remote, wirelessly controlled, boat winch attached to the trailer in the standard position. The pivot arm assembly functions as a self-tending positioning system to which the winch's cable/strap hook is held. The pivot arm assembly can include, for example, a central spine of square aluminum tubing to which a pivoting frame mount, one or more bottom weights, one or more positioning protective rollers, an eyehook for winch cable connection, and an optional extendable marker-mast are attached.

For boat launching from the trailer, the pivot arm assembly rests in a horizontal position beneath the boat, held horizontally by the boat. Biased by the one or more weights, the pivot arm assembly rises slowly to near vertical position as the boat is eased back off the trailer into the water as the user engages the electric winch for launch. Once the boat is floating in the water, the user, while in the boat, disconnects the winch hook from the boat, attaches the winch hook to the pivot arm assembly eyehook, and backs the boat away from trailer. This leaves the pivot arm assembly in a near vertical position with the winch hook attached to the eyehook and marker-mast extended upward. In this position, the boat trailer system is now ready to load the boat.

For boat loading onto the trailer, the user drives the boat on the trailer up to point that the boat's bow touches the pivot arm assembly. The user, while remaining in the boat, removes the winch cable hook from the pivot arm assembly and attaches the winch cable hook to the bow eye of the boat. The user then moves to a position aft in the boat and engages the electric winch through its wireless remote control. As the boat is pulled onto trailer, the pivot arm assembly is gently pushed forward by the boat's hull from the vertical position to a horizontal position beneath the boat. The user then steps off the bow, onto the trailer and then onto the tow vehicle.

Embodiments of the present invention enable a user to now safely and efficiently launch and load any single hulled power vessel up to 26′ or more single handedly. In some embodiments, a simple ladder structure may be mounted on the trailer to facilitate access to and from the trailer to the bow of boat. In some embodiments, a pole mounted snap clip may be included to facilitate attachment/detachment of the winch hook to the bow eye, for example, on larger vessels.

Embodiments of the invention can be applied to trailers for power or other boats ranging from approximately fifteen to approximately twenty-six feet in length that use either roller or bunk construction as the primary method of support during launch, loading and transport. Other larger and smaller sized trailers as well as trailers with different support types can also use the pivot arm assembly of the present invention.

In contrast to the launch process of embodiments of the present invention, the conventional process normally involves at least two individuals and many steps. User One backs the truck and trailer into the water while User Two has to climb into the boat and wait aboard as the trailer is backed into the water. User One a) parks and blocks the truck, b) removes his shoes (or wears long boots) enters the water and walks the length of trailer tongue to the manual winch stand. In some cases, the user will climb precariously along the trailer tongue in an attempt to remain dry. User One the c) releases the safety chain, d) manually applies pressure to the winch handle to release the winch locking mechanism so that boat can begin to roll or float off trailer, e) removes the winch cable snap from the boat's bow eye, f) collects the slack winch cable, g) secures the slack cable at the winch stand, h) walks out of the water, i) dries his feet or removes his wet boots, j) puts his shoes on, and k) finally drives the truck up the ramp and parks in a lot. Meanwhile, User Two a) engages the boat's engine, b) backs the boat off the trailer, and c) docks the boat at the ramp.

Likewise, the conventional loading process normally involves at least two individuals and many steps. User one a) backs the trailer into the water, b) User Two positions boat on the trailer as far as the rollers or bunks will allow and waits onboard until the boat is pulled out of the water, c) User One removes his shoes (or wears long boots), enters the water and walks the length of trailer tongue to the manual winch stand. In some cases, the user will climb precariously along the trailer tongue in an attempt to remain dry. User One then d) connects the cable snap to the bow eye of the boat, e) manually cranks the winch so that boat is pulled firmly up to the winch stand/bow post, f) attaches the safety chain, g) walks out of the water, h) dries his feet/removes his wet boots, i) puts his shoes on, and j) drives the truck up the ramp and parks in the lot. Note that even if an electric winch is used in the launch and load processes, these processes typically remain the same as above with the exception that electric winch is used in place of the manual winch to eliminate physical effort and risk of injury associated with this step in the process.

As mentioned above, the pivot arm assembly serves as a self-tending positioning system for the winch's cable/strap hook to be attached. The following very specific, detailed embodiment is provided merely to illustrate a particular example construction of a pivot arm assembly. In some embodiments, the pivot arm assembly can be constructed from one approximately 4′×1½″×⅛″ central spine of square aluminum tubing, for example. The pivot arm assembly can be attached approximately 14″ from the bottom of the arm to pivot bolt hole via an approximately 4″ galvanized frame mount bracket and an approximately 6″×½″ hexagonal stainless-steel bolt and nut which runs horizontally thru two approximately 3″×1⅜″×½″ center hole, solid wheel pivot rollers. The frame mount can be attached to the trailer with two, approximately ½″×3⅜″×4″ galvanized U-bolts. In some embodiments, a secondary roller can be attached approximately 20″ from the bottom of the pivot arm to pivot roller to prevent the pivot arm assembly from scraping the hull of the boat. Secondary roller can be an approximately 3″×3″×½″ poly center hole attached thru the arm with approximately 5″ roller bar with end caps. A primary roller can be attached approximately 9¼″ above the secondary roller. The primary roller aids in positioning the boat relative to the pivot arm, preventing damage to the bow when the pivot arm assembly is rising, lowering and in the upright position. The primary roller can be constructed from parts of an approximately 5″×⅝″ poly keel roller and an approximately 3″×3×½″ center hole poly roller. An approximately 1⅜″ stainless steel shackle “eyehook” can be attached at the top end of the pivot arm for the winch cable connection. An approximately 4′×⅜″ extendable fiberglass marker-mast can be attached near the top end of the pivot arm to aid positioning of the boat when loading. Approximately fifteen pounds of lead ballast can be coupled to the lower end of the pivot arm for biasing by inserting one approximately five pound, approximately 9″×1 3/16″×1 3/16″ lead ingot into the lower portion of the aluminum arm and attaching two similar approximately five pound weights each encased in approximately 1¼″×1¼″×8¾″ aluminum sleeves attached at the lower left and right sides of the pivot arm assembly via two approximately ¼″×5″ stainless steel hex bolts. The above detailed example embodiment is provided for illustrative purposes only. Other dimensions, sizes, positions, shapes, and materials can be used as practicable.

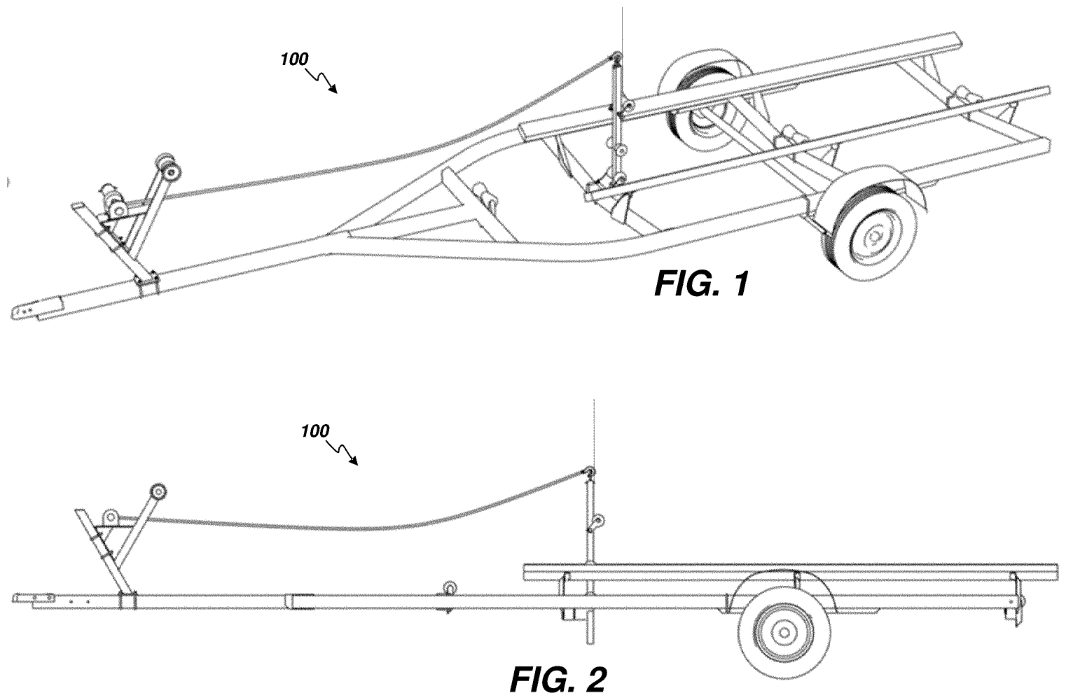

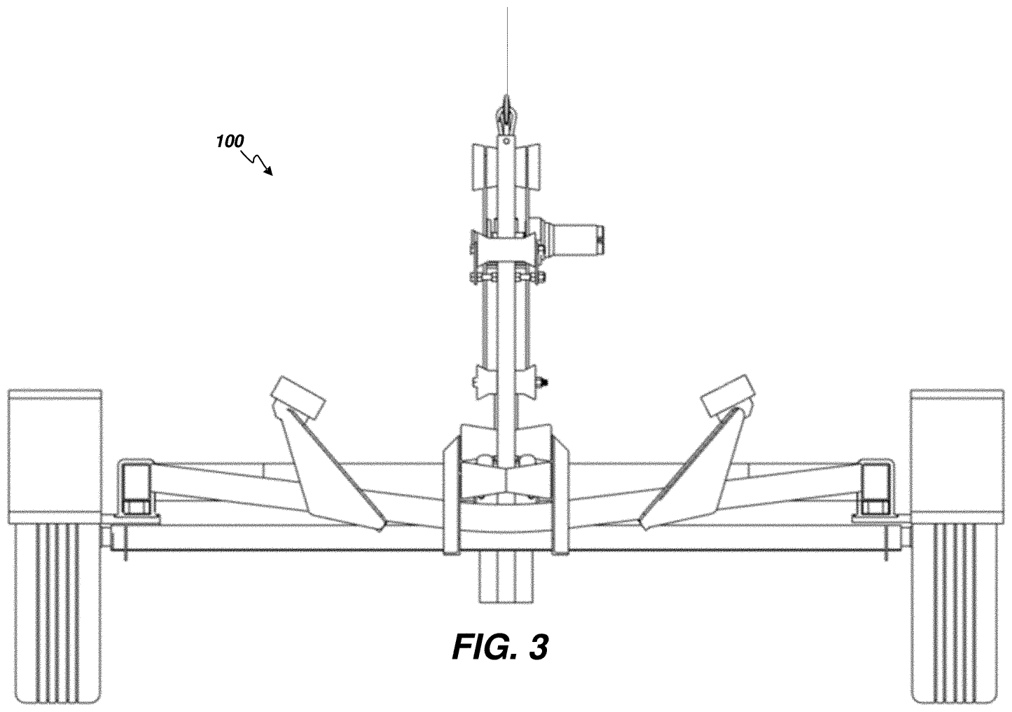

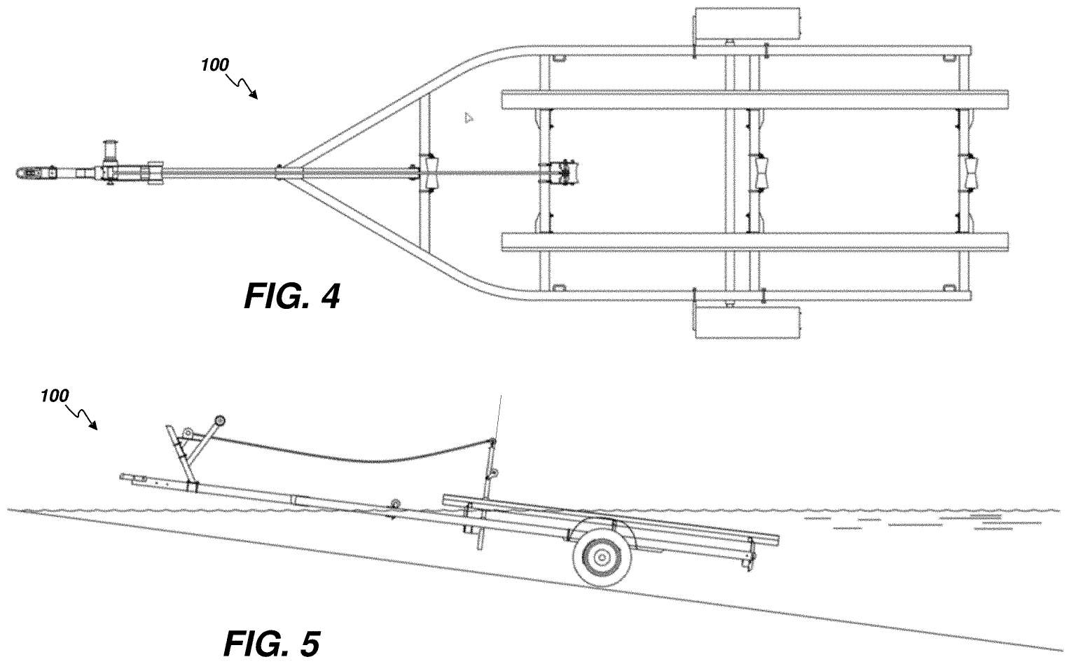

Turning now to FIG. 1, an example of a boat trailer system 100 according to embodiments of the present invention is shown. FIG. 2 is a side view of the boat trailer system 100 of FIG. 1. FIG. 3 is an end view of the boat trailer system 100 of FIG. 1. FIG. 4 is a top view of the boat trailer system 100 of FIG. 1.

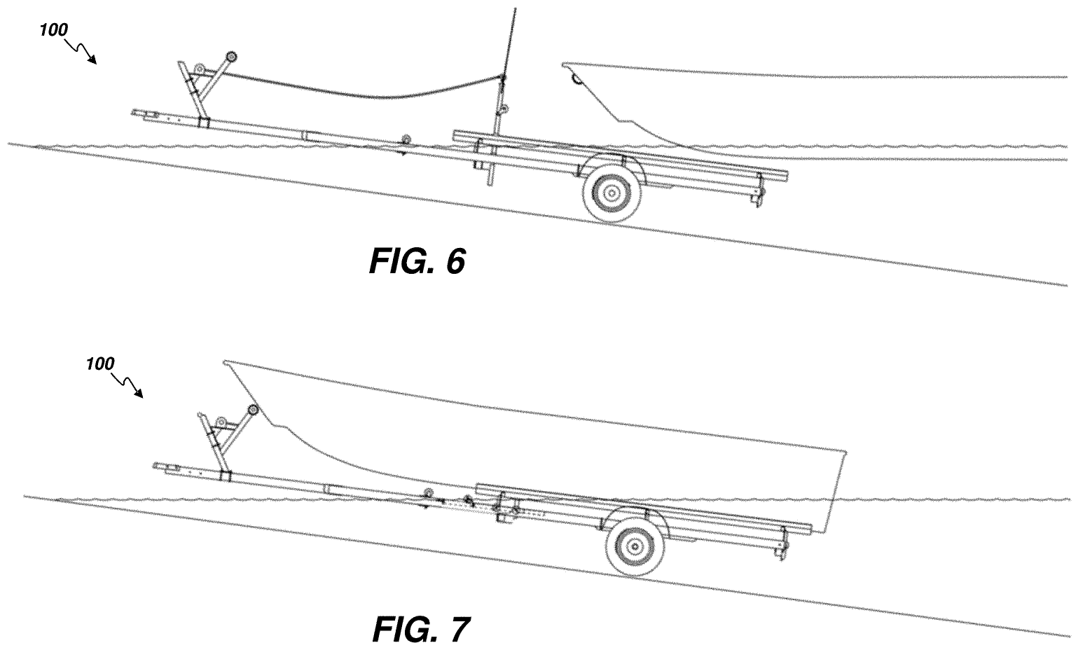

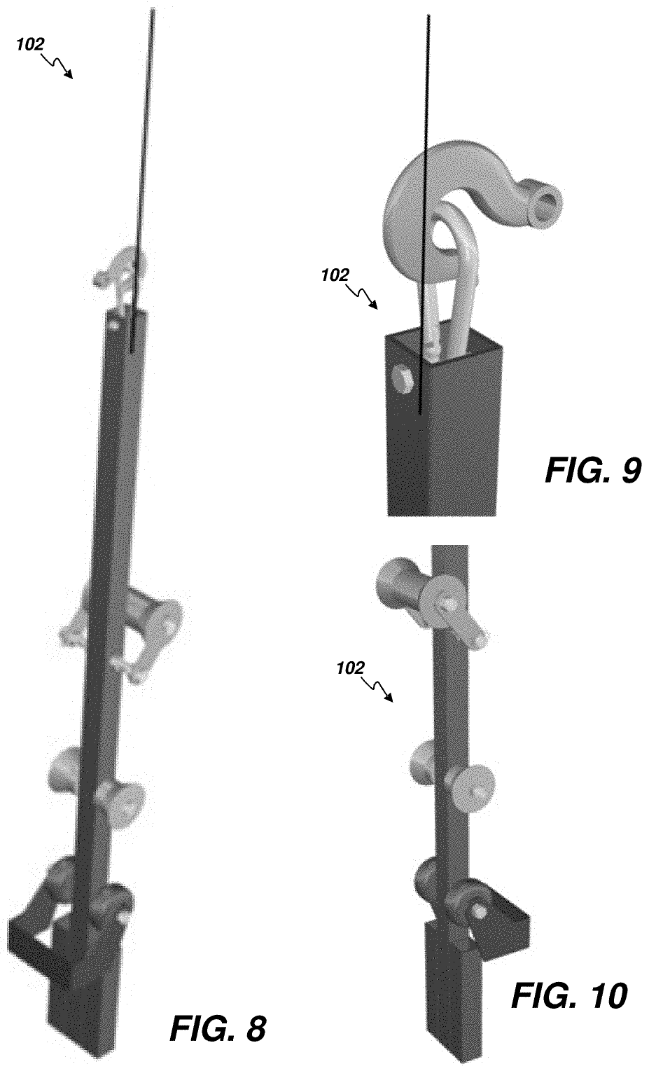

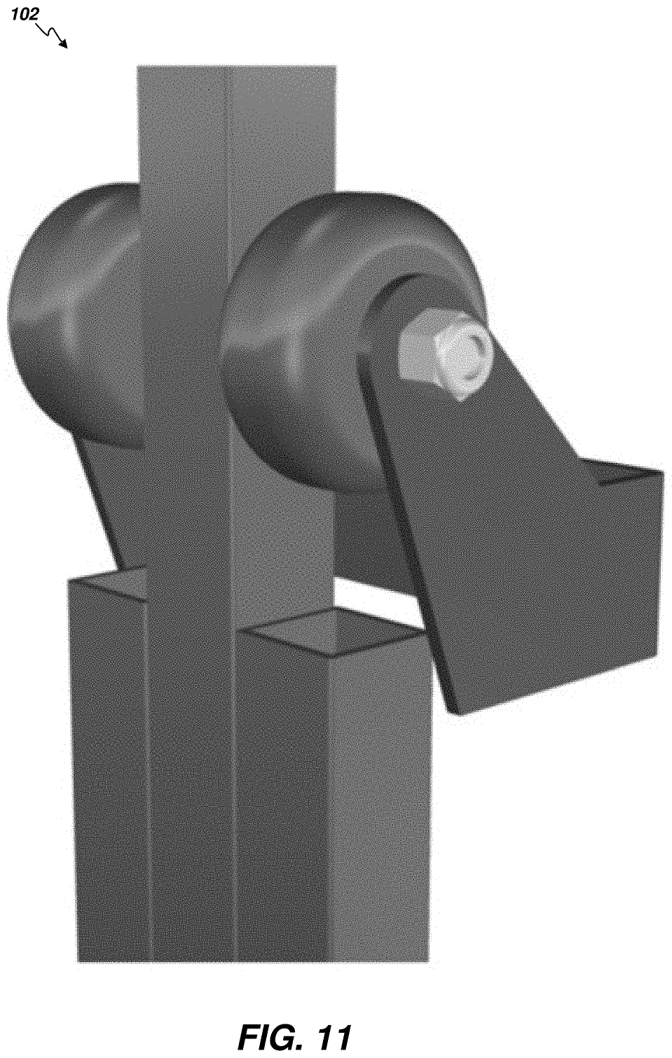

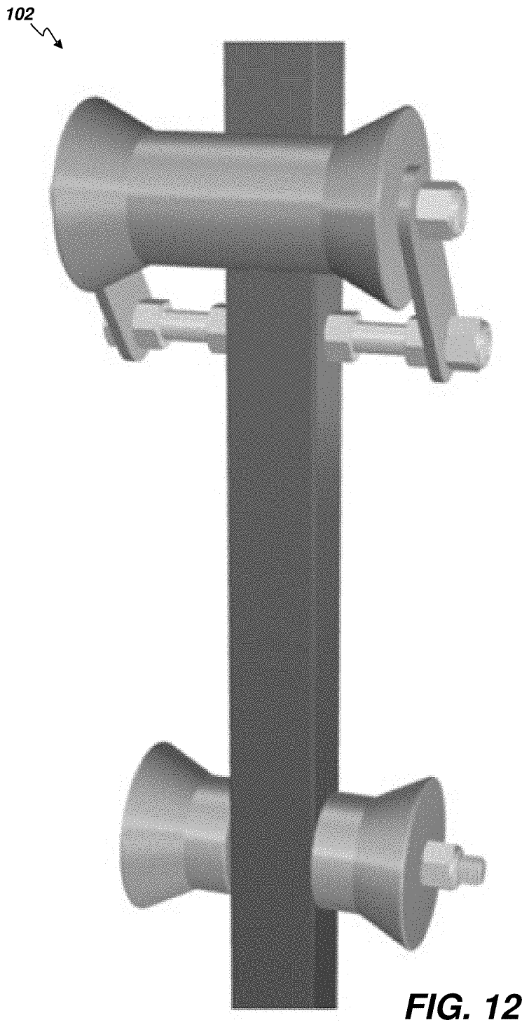

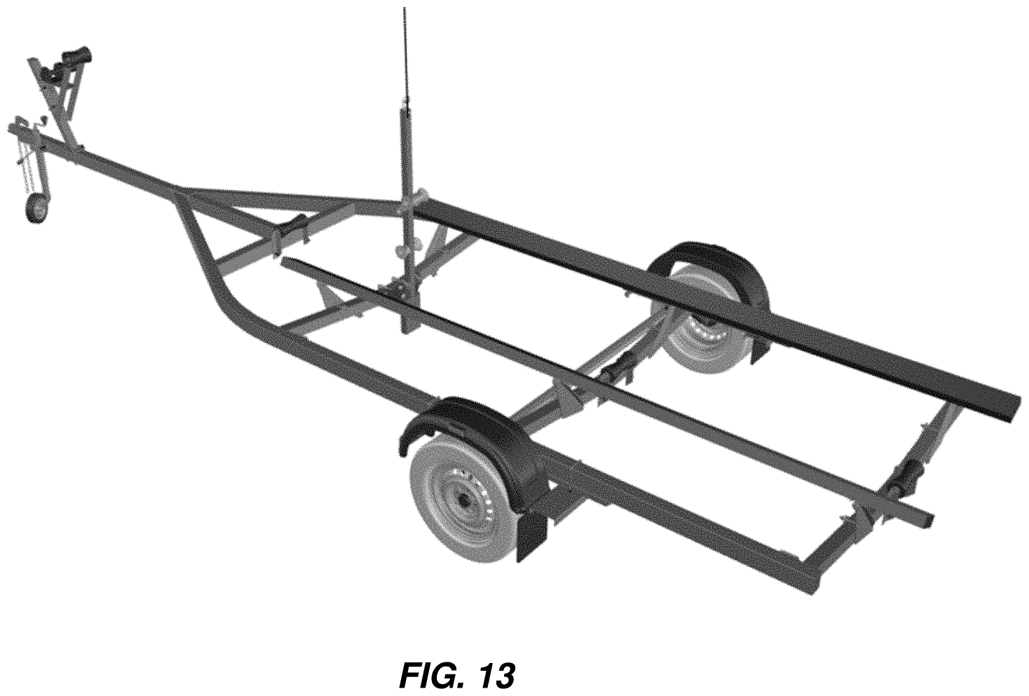

FIG. 5 depicts an example of a boat trailer system 100 ready for use to load a boat, FIG. 6 depicts the example boat trailer system 100 in use loading a boat, and FIG. 7 depicts the example boat trailer system 100 with a boat loaded. FIG. 8 is a magnified view of an example of a pivot arm assembly 102 of a boat trailer system 100 according to embodiments of the present invention. FIG. 9 is a magnified view of the upper portion of the example pivot arm assembly 102 and FIG. 10 is a magnified view of the lower portion of the example pivot arm assembly 102. FIG. 11 is a further magnified view of a mounting portion of the pivot arm assembly 102 and FIG. 12 is a further magnified view of a roller portion of the example pivot arm assembly 102. FIG. 13 is a rear perspective view diagram depicting the example boat trailer system 102 of FIG. 1.

Numerous alternative embodiments and enhancements are possible. One or more boarding ladders can be included to provide easy, safe, and dry access to the boat from the truck or SUV and back. Alternatives to accomplish this include but, are not limited to a) Single vertical post with horizontal cross bar steps (˜12″×2″×1″); the number of cross bar steps depends on the height from trailer tongue to bow gunwale. Typically range from 2-3 steps for boats up to 20′ and 4-6 steps for boats larger than 21′. The single vertical post is attached to trailer winch post. Attachment could be permanently welded or removable using U-bolts and plastic swim ladder with rotatable top arms. Attached to trailer tongue and/or post with U-bolts.

A winch cable/strap connector for boats with distance greater than 24″ from bow gunwale to pivot arm's eyehook and boat's bow-eye. Winch cable/strap connector is necessary when distance from boats bow gunwale to pivot arm's eyehook and boats bow eye is greater than can be comfortably reached by an operator from bow of the boat. Designs for the cable/strap connector include: a) extendable boat hook (4-8′) with attachable slide on—slide off removable snap hook and b) other similar devices.

Alternative winch designs and enhancements to the standard winch post configuration could include a) Truck/SUV trailer hitch mounted winch. Two blocks would be attached to trailer to create proper haul and release angle for cable/strap b) use of a non-marine ATV winch c) boat trailer mounted 12 v winch battery to supply dedicated power and avoid any drain on tow vehicles battery d) oversized winch. Install larger capacity winch than recommended by manufacturer to increase pulling power and speed of operation.

Boat trailer post guides can be provided. Two PVC tubes that extend vertically from back of boat trailer, one on each side, aid in aligning and maintaining position as boat is driven on or backed off trailer.

Truck wheel blocks can be provided. These prevent the truck from accidentally rolling back during launch or haul maneuvers. Proper use helps avoid personal injury or property damage.

A winch cover can be provided. A self-securing, form fitting canvas or other material, cover could be added to protect winch from weather to extend its useful life. A carrying case for remote winch control can be provided. A small carrying case for remote winch control could be secured near helm of boat to ensure remote is always available when and where it is needed. Carrying case should include back up batteries.

Numerous alternative uses are possible. Launch and loading of multi-hull boats is possible. Embodiments depicted in the FIGs. are for launching and hauling mono-hull boats. Minor modifications could be made (e.g., adding a Y-adapter and/or bridal) to provide appropriately positioned points of connection for launching and hauling catamarans, pontoon boats and other multi-hull vessels.

In some embodiments, the launching and loading of larger mono-hull trailerable boats is possible. Use of larger components would allow launching and hauling boats ranging in size from 27′ to 35′.

A dock line assist can be provided. Docking can be stressful in periods of heavy wind or inclement weather. Wind can blow vessels away from the dock, lines on a dock can be hard to reach and secure. In some embodiments, a pivot arm assembly could be mounted in a slip or on a pier/piling to remotely present dock lines at perfect position and height for vessels entering the slip.

A boat cockpit shade assist can be provide. A pivot arm assembly can be adapted to create an aft cockpit mechanism to enable automated shade placement for center cockpit and other vessels.

There are many design variations possible from the above described embodiment. A lightweight version with PVC arm(s), bottom weighted and wrapped in protective foam. Rubber based rollers can be used for a less expensive version. This accomplishes the inventions objectives at much lower cost and simple design. Galvanized bolts and roller hardware can be used. A wired winch can be used. A winch with a 2000 lbs to 15000 lbs pull capacity can be used. For boats with lengths of 17′ to 26′poly carbon rollers, stainless steel bolts and roller hardware can be used. For boats with lengths of 26′ to 35′, larger polycarbon rollers and associated hardware, larger winches, an adjustable winch cable/strap connector, heavier gauge aluminum tubing for pivot arm, a larger diameter stainless steel bolts and roller hardware, and up to a 15,000 lbs winch pull capacity can be used. The counterbalance configuration can be implemented with lead ingots (smelted and poured or saw cut), lead shot, composite or concrete.

Numerous embodiments are described in this disclosure and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a winch, a rope, a bow eye” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

The foregoing description discloses only example embodiments of the invention. Modifications of the above-disclosed apparatus, systems and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

The invention claimed is:

1. A boat trailer system comprising:
a boat trailer; and
a pivot arm assembly coupled to the boat trailer and adapted to hold a winch hook in reach of a bow of a boat to be loaded onto or launched from the boat trailer,
wherein the pivot arm assembly is operative to pivot horizontal under the boat when the boat is loaded on the boat trailer and biased to pivot up into a vertical position when the boat is launched from the boat trailer.

2. A kit comprising:
a pivot arm assembly couplable to a boat trailer and adapted to hold a winch hook in reach of a bow of a boat to be loaded onto or launched from the boat trailer,
wherein the pivot arm assembly is operative to pivot horizontal under the boat when the boat is loaded on the boat trailer and biased to pivot up into a vertical position when the boat is launched from the boat trailer.
